(19) United States
(12) Patent Application Publication
(10) Pub. No.: US 2009/0026848 A1
(43) Pub. Date: Jan. 29, 2009

(54) LINEAR MOTOR

(76) Inventors: Houng Joong Kim, Mito (JP); Hitoshi Shibata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/280,024

(22) PCT Filed: Mar. 31, 2006
(86) PCT No.: PCT/JP2006/307393

§ 371 Date: Aug. 20, 2008

(51) Int. Cl. H02K 41/02

(52) U.S. Cl. 310/12

(57) ABSTRACT

In prior art linear motor, since magnetic attractive force acts in one direction between an armature and a moving member, heavy burden is imposed on a supporting mechanism of the moving member, distorting the structure and causing various troubles. Inventive linear motor includes a stator having armature winding and moving member having permanent magnets arranged to move relatively. The linear motor stator includes rink-like cores, armature teeth and armature winding to constitute a magnetic circuit. Slit grooves are disposed in the armature teeth opposite to both of the obverse and reverse sides of the permanent magnets of the moving member through air gap and protrusion members movable along the slit grooves of the armature teeth and a member having the permanent magnets include a part in contact with other members, the part being made of material having high endurance.

### TECHNICAL FIELD

The present invention relates to a linear motor and more particularly to a linear motor including primary-side members having ring-like cores, armature teeth and an armature winding constituting a magnetic circuit and secondary-side members having permanent magnets disposed in part of the ring-like cores through air gap to be reciprocated.

### BACKGROUND ART

A prior art linear motor has a main structure in which a rotor is cut open to be developed on a straight line and comprises a stator having an armature winding and a moving member supported to be able to be moved relatively to the stator through air gap. Accordingly, large magnetic attractive force acts between the stator and the moving member, so that a heavy burden is imposed on a supporting mechanism which maintains the air gap to be fixed and the whole apparatus is large in size.

Furthermore, in the prior art, a plurality of windings are wound on one stator unit and different windings are wound on adjacent stator magnetic poles, so that the structure of the whole apparatus is complicated.

It is an object of the present invention to solve the above defects by providing a linear motor having the compact structure by devising the arrangement method of an armature winding and the enhanced rigidity of secondary-side members having permanent magnets while canceling magnetic attractive force acting between primary-side members (stator) and the secondary-side members (moving member) and maintaining the characteristics of a magnetic circuit.

As a patent document concerning the prior art linear motor, International Patent Publication WO00/69051 may be referred to.

### DISCLOSURE OF INVENTION

In order to achieve the above object, according to the present invention, the linear motor includes a plurality of permanent magnets disposed along a moving direction and cores disposed opposite to both of obverse and reverse sides of the permanent magnets to form a closed magnet path. Slit grooves are formed in armature teeth of the cores and protrusion members are disposed to be able to be moved along the slit grooves. A member having the permanent magnets includes part being in contact with other members, the part being made of material having high endurance.

In order to achieve the above object, according to the present invention, the linear motor includes a plurality of permanent magnets disposed along a moving direction and cores disposed opposite to both of obverse and reverse sides of the permanent magnets to form a closed magnet path. Slit grooves are formed in armature teeth of the cores and a member having the permanent magnets includes protrusion members which can be moved along the slit grooves. A supporting member for supporting the protrusion members is provided.

### BRIEF DESCRIPTION OF THE DRAWINGS

FIG. 1 illustrates basic structure of a linear motor according to an embodiment of the present invention;

FIG. 2 illustrates ring-like cores and arrangement of permanent magnets of the linear motor according to the embodiment of the present invention;

FIG. 3 illustrates a supporting mechanism (part 1) of a linear motor according to another embodiment of the present invention;

FIG. 4 illustrates a supporting mechanism (part 2) of a linear motor according to another embodiment of the present invention;

FIG. 5 illustrates a supporting mechanism (part 3) of a linear motor according to another embodiment of the present invention;

FIG. 6 illustrates a moving member of the linear motor according to the embodiment of the present invention as compared with a moving member of a linear motor in the prior art;

FIG. 7 illustrates a core and a moving member (part 1) of a linear motor according to another embodiment of the present invention;

FIG. 8 illustrates a core and a moving member (part 2) of a linear motor according to another embodiment of the present invention; and

FIG. 9 is a schematic diagram illustrating a servo control system using the linear motor of the present invention.

### BEST MODE FOR CARRYING OUT THE INVENTION

Embodiments of the present invention are now described with reference to the accompanying drawing. In the drawings, the like reference numerals designate the like or equivalent constituent elements.

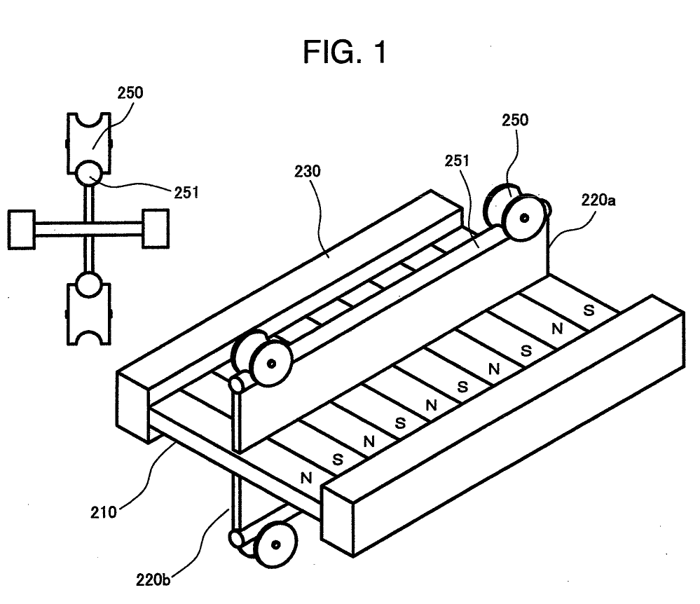

FIG. 1 is a schematic diagram illustrating a linear motor according to an embodiment of the present invention.

In FIG. 1, protrusions 220a and 220b are disposed on both of the obverse and reverse sides of a moving member 210 constituting a primary-side member in the longitudinal direction of the moving member 210 in which permanent magnets are disposed in order of N, S, N and S poles. Moreover, rails 251 made of material having endurance higher than that of the protrusions are disposed along the protrusions 220a and 220b and rollers 250 are disposed to support the rails 251 as supporting members.

A supporting mechanism 230 is disposed on both sides of the moving member 210, although the supporting mechanism and guide rails (not shown) of the moving member may be combined in a mixed manner. Furthermore, as the supporting method thereof, a non-contact supporting method using aero static bearing or hydrostatic bearing or a supporting method using plane sliding or linear guide rails may be used.

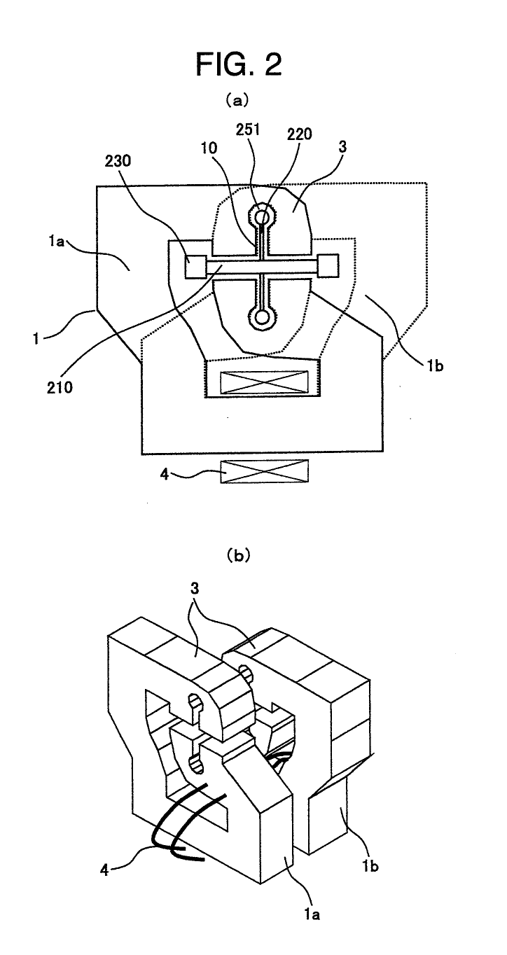

FIG. 2 illustrates ring-like cores and arrangement of a permanent magnet part of the linear motor according to the embodiment of the present invention.

In FIG. 2, an armature winding 4 are disposed or wound on an odd-numbered ring-like core 1a and an even-numbered ring-like core 1b in common. In FIG. 2(b), only 2 ring-like cores are shown, although one armature winding 4 may be wound on 2 or more odd-numbered ring-like cores and even-numbered ring-like cores.

Consequently, a current flows through the single armature winding, so that magnetic fields in opposite directions can be formed between magnetic poles of adjacent cores.

In FIG. 2, the linear motor includes a stator constituting primary-side member having an armature winding 4 and moving member 210 constituting secondary-side member having permanent magnets, which can be moved relatively. The basis system structure is the same as the contents described in the International Publication WO00/69051, unless mentioned otherwise.

The stator of the linear motor includes ring-like cores 1, armature teeth 3 and the armature winding 4 to constitute a magnetic circuit. Slit grooves 10 are formed in the armature teeth 3 in part of the ring-like cores opposite to both of the obverse and reverse sides of the permanent magnets of the moving member through air gap and the protrusion members 220 are disposed on the permanent magnets to be able to be moved along the slit groove 10 of the armature teeth 3. Moreover, rails 251 made of material having endurance higher than that of the protrusions are disposed along the protrusions 220a and 220b and rollers 250 supporting the rails 251 are disposed in ring-like cores 1 as supporting members.

The rollers 250 are disposed above and below both ends of the arranged odd-numbered ring-like core 1a and even-numbered ring-like core 1b and further when there are a plurality of ring-like core units, the rollers 250 may be disposed above and below between the portions where the units are not disposed.

Further, the armature teeth 3 are disposed in part of the ring-like cores through air gap in an opposing manner to both of the obverse and reverse sides of the permanent magnets of the moving member 210 and guide rails 230 are disposed along the longitudinal direction of the moving member. The armature winding 4 is not necessarily required to be wound on the ring-like cores in common to all of them and the armature winding may be disposed in any place as far as the moving member 210 can be moved freely.

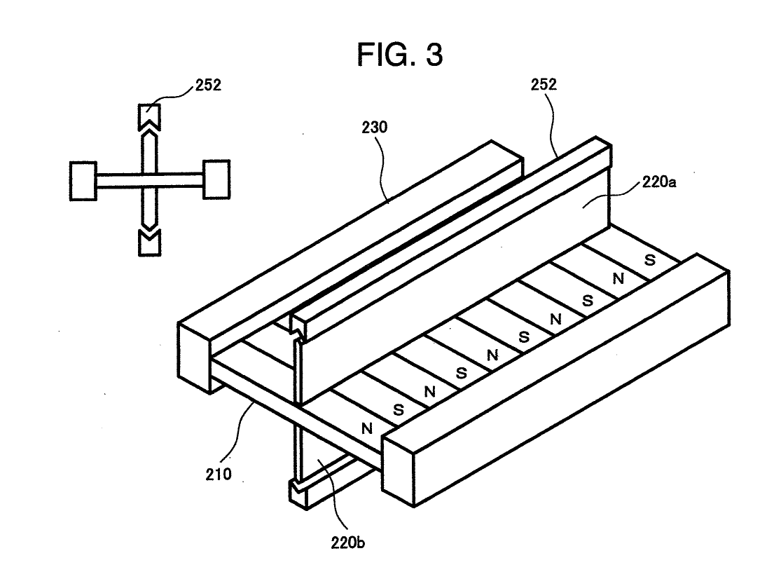

FIG. 3 illustrates a supporting mechanism of a linear motor according to another embodiment of the present invention.

In FIG. 3, the supporting mechanism 252 is disposed along the protrusions 220 so that the relative movement can be attained. For example, the supporting mechanism such as cross rollers is provided in the ring-like cores.

The cross rollers can be disposed over the total length of the ring-like cores along the protrusions 220. Furthermore, when there are a plurality of ring-lie core units, the cross rollers may be disposed in only the portions where the units are disposed without disposing the cross rollers between the core units.

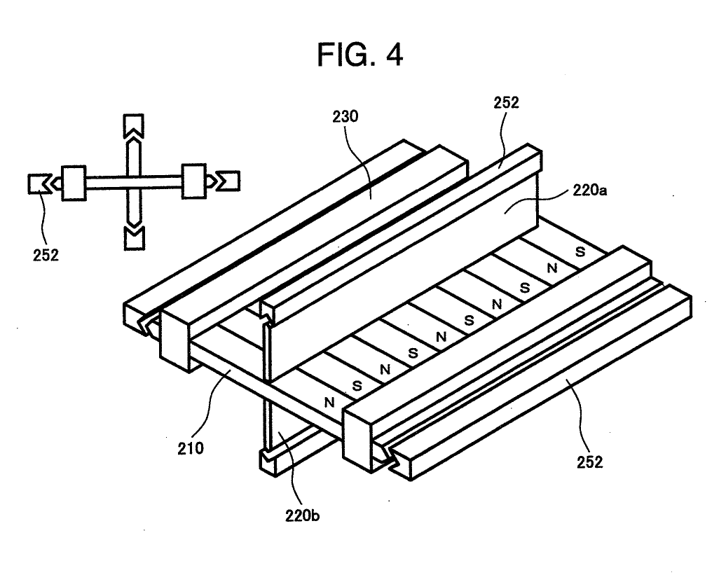

FIG. 4 illustrates a supporting mechanism of a linear motor according to another embodiment of the present invention.

In FIG. 4, the supporting mechanism 252 is disposed along the protrusions 220 and furthermore a supporting mechanism 252 is also disposed along the guide rails 230, so that the relative movement of the moving member and the stator is supported more stably. Only the supporting mechanism 252 may be disposed along the guide rails without disposing the supporting mechanism 252 along the protrusions 220. Only necessary supporting mechanism may be selectively disposed in accordance with the structure of the apparatus.

The supporting mechanisms 252 can be disposed over the total length of the ring-like cores along the protrusions 220 and the guide rails 230 similarly to the above embodiments. Furthermore, when there are a plurality of ring-like core units, the supporting mechanism may be disposed in only the portions where the units are disposed without disposing the supporting mechanism between the core units.

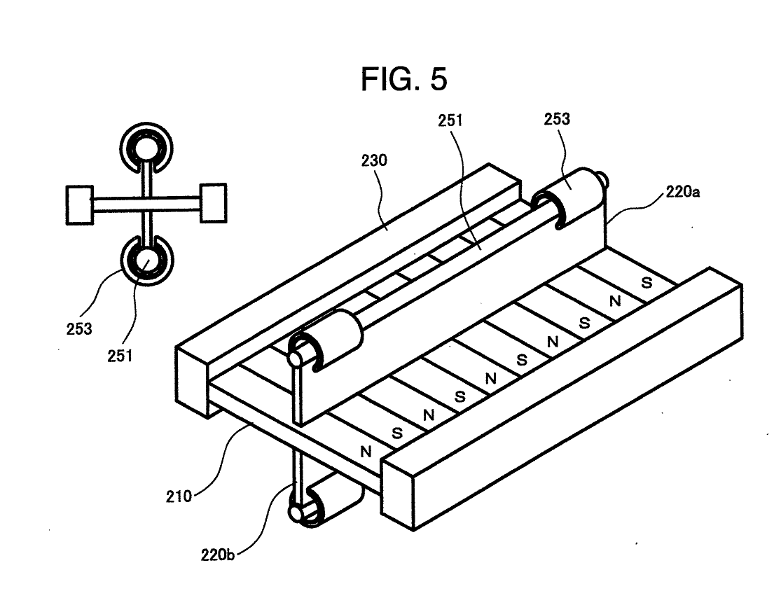

FIG. 5 illustrates a supporting mechanism of a linear motor according to another embodiment of the present invention.

In FIG. 5, sliders 253 are used instead of the rollers 250 shown in FIG. 1, and the rails 251 and the sliders 253 are combined to support the relative movement of the moving member and the stator more stably.

The sliders 253 can be disposed over the total length of the ring-like cores along the protrusions 220 similarly to the above embodiments. Furthermore, when there are a plurality of ring-like core units, the sliders 253 may be disposed in only the portions where the units are disposed without disposing the sliders between the core units.

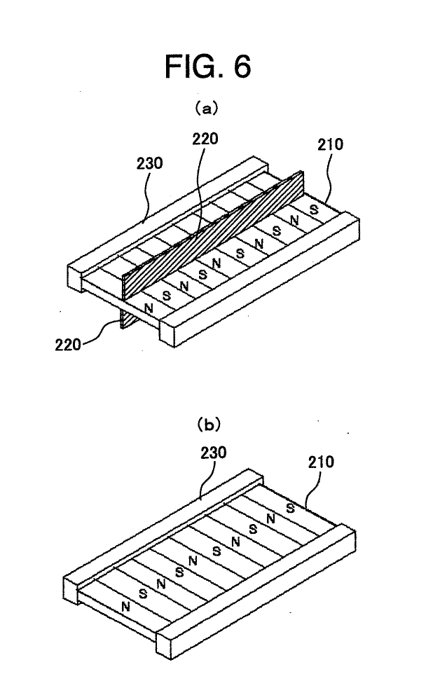

FIG. 6 illustrates a moving member of the linear motor according to the embodiment of the present invention as compared with a moving member of a linear motor in the prior art.

FIG. 6(a) illustrates the moving member of the linear motor of the present invention including the protrusion members 220 disposed at center parts on both of the obverse and reverse sides of the moving member 210 and FIG. 6(b) illustrates the moving member of the prior art linear motor without protrusion member disposed at center parts on both of the obverse and reverse sides of the moving member 210. In the linear motor of the present invention, the protrusion members 220 are disposed at center parts on both of the obverse and reverse sides of the moving member 210, so that the moment of inertia of area (sectional moment of the second order) of the moving member is increased and the rigidity is enhanced.

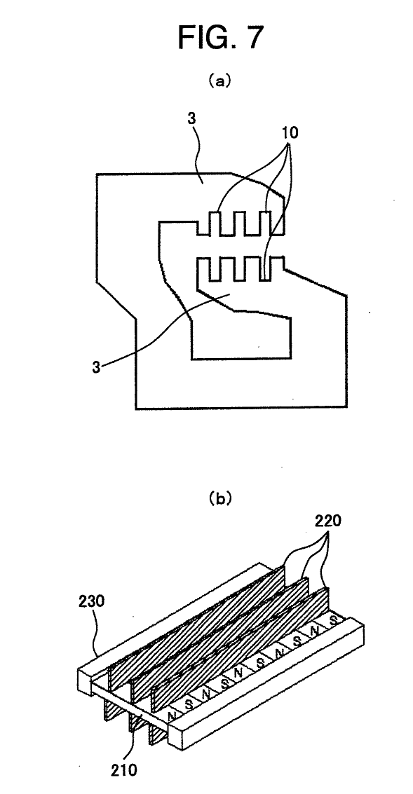

FIG. 7 illustrates a core and a moving member of a linear motor according to another embodiment of the present invention.

FIG. 7(a) shows a plurality of slit grooves 10 (6 slit grooves in total including 3 slit grooves in the upper part and 3 slit grooves in the lower part are shown in FIG. 15) formed in the armature teeth 3 in part of the ring-like core opposite to both of the obverse and reverse sides of the permanent magnets of the moving member 210 through air gap. FIG. 7(b) shows a plurality of protrusion members 220 disposed on both of the obverse and reverse sides of the moving member 210 in a corresponding manner to the groove form of the armature teeth. Provision of such structure more enhances the rigidity of the moving member of the secondary-side member.

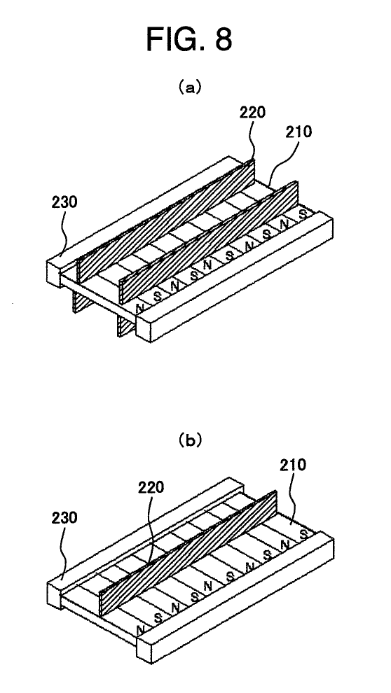

FIG. 8 illustrates a moving member of a linear motor according to another embodiment of the present invention.

FIG. 8(a) shows two protrusion members shifted from the center of the moving member 210 in case where the plurality of protrusion members are disposed on both of the obverse and reverse sides of the moving member 210. Even in such structure, the rigidity of the moving member can be enhanced.

Further, FIG. 8(b) shows the protrusion member disposed on one of the obverse and reverse sides of the moving member 210 along the longitudinal direction thereof. Even in such structure, the rigidity of the moving member can be enhanced.

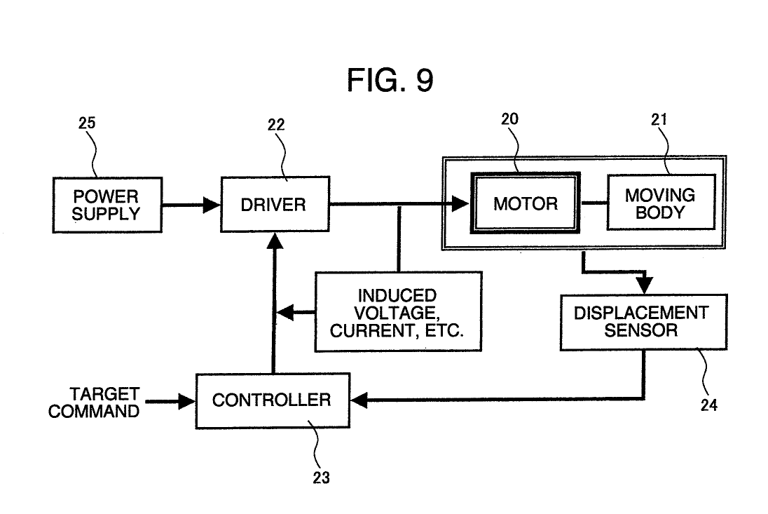

FIG. 9 is a schematic diagram illustrating a servo control system using the linear motor of the present invention.

The linear motor 20 of the present invention is connected to a moving body 21 and the system includes a driver 22, a controller 23 and a displacement sensor 24 and drives the linear motor in accordance with a target command. The system of FIG. 9 constitutes a closed loop control system using the displacement sensor 24, although the system can attain open loop control without the displacement sensor depending on use. Moreover, a current sensor, a magnetic pole sensor (not shown) and the like can be used to attain the servo control system having high accuracy and high performance.

In FIG. 9, the displacement sensor 24 includes an encoder scale (not shown) disposed along the longitudinal direction of the moving member 210 similarly to the prior art linear motor and an encoder detector (not shown) disposed in a corresponding manner to the encoder scale and can be used as a linear driving device.

The ring-like cores or the armature winding disposed in the armature teeth of the linear motor of the present invention has been described by way of example, although the ring-like cores and the armature winding may be combined in a mixed manner.

In the embodiments of the linear motor of the present invention as described above, the moving member is disposed on the side of the permanent magnets and the stator is disposed on the side of the armature winding, although conversely the moving member may be disposed on the side of the armature winding and the stator may be disposed on the side of the permanent magnets.

Moreover, besides the embodiments having the above-mentioned combination, only a part of the combination may be adopted. The constituent elements of the linear motor shown in the drawings may be combined across the embodiments shown in the drawings regardless of the embodiments and the combined elements may be molded.

### INDUSTRIAL APPLICABILITY

As described above, according to the present invention, there is provided the linear motor in which the magnetic attractive force acting between the stator and the moving member can be canceled while the arrangement method of the armature winding is devised to have the compact structure. Moreover, there can be provided the linear motor having the high rigidity of the members including the permanent magnets and which can be manufactured inexpensively by simple structure by making the part being in contact with the supporting member, of material having high endurance.

1. A linear motor including a plurality of permanent magnets disposed along a moving direction and cores disposed opposite to both of obverse and reverse sides of the permanent magnets to form a closed magnet path, wherein
slit grooves are formed in armature teeth of the cores and
protrusion members are disposed to be able to be moved along the slit grooves,
a member having the permanent magnets including part being in contact with other members, the part being made of material having high endurance.

2. A linear motor according to claim 1, wherein
both ends of the member having the permanent magnets are made of material having high endurance.

3. A linear motor according to claim 1, wherein
rollers are provided as members for supporting the protrusion members.

4. A linear motor according to claim 1, wherein
cross rollers are provided as members for supporting the protrusion members.

5. A linear motor according to claim 1, wherein
sliders are provided as members for supporting the protrusion members.

6. A linear motor according to claim 1, wherein
a stator is fixedly supported and a moving member is moved.

7. A linear motor according to claim 1, wherein
a moving member is fixedly supported and a stator is moved.

8. A linear motor including a plurality of permanent magnets disposed along a moving direction and cores disposed opposite to both of obverse and reverse sides of the permanent magnets to form a closed magnet path, wherein
slit grooves are formed in armature teeth of the cores and
a member having the permanent magnets includes protrusion members which can be moved along the slit grooves,
a supporting member for supporting the protrusion members is provided.

9. A linear motor according to claim 8, wherein
the member having the permanent magnets including part being in contact with the supporting member, the part being made of material having high endurance.

10. A linear motor according to claim 8, wherein
rollers are provided as members for supporting the protrusion members.

11. A linear motor according to claim 8, wherein
cross rollers are provided as members for supporting the protrusion members.

12. A linear motor according to claim 8, wherein
sliders are provided as members for supporting the protrusion members.
